(19) United States
(12) Patent Application Publication
(10) Pub. No.: US 2017/0005992 A1
(43) Pub. Date: Jan. 5, 2017

(54) SECURE MESSAGE TRANSMISSION USING DYNAMIC SEGMENTATION AND ENCRYPTION

(71) Applicant: Vadium Technology Corporation, Seattle, WA (US)

(72) Inventors: Zsolt Ari, Seattle, WA (US); John Koisch, Lakewood, WA (US); William Yakamovich, Fall River (CA); Dawson Cowals, Portland, OR (US); Rod Nicholls, Renton, WA (US)

(73) Assignee: Vadium Technology Corporation, Seattle, WA (US)

(21) Appl. No.: 15/065,606

(22) Filed: Mar. 9, 2016

Related U.S. Application Data
(60) Provisional application No. 62/130,458, filed on Mar. 9, 2015.

(51) Int. Cl. H04L 29/06

(52) U.S. Cl. CPC H04L 63/045; H04L 63/06

(57) ABSTRACT

Apparatus, methods, and non-transitory computer readable media for securely sending a digital message from a sending device (1) to a recipient device (3) over an open network (4) such as the Internet. In a method embodiment of the present invention, a system controller (5) instructs the sending device (1) to segment the message into a finite number of segments having variable lengths; and assigns a variable number of relay (2) hops to each segment. The segments then flow from the sending device (1) to the recipient device (3) via several layers of conventional network relays (2). At least some of the segments are encrypted, by the sending device (1) and/or by one or more autonomous agent modules (30) operating on the relays (2). This invention makes it virtually impossible to track what is happening at the relays (2), or to identify the intended recipient (3). This virtually eliminates network traffic analysis as a viable means of compromising the security of the communications.

### RELATED APPLICATION

This patent application claims the priority benefit of commonly owned U.S. provisional patent application Ser. No. 62/130,458 filed Mar. 9, 2015 entitled “Encryption Key Distribution and Data Transmission Using Dynamic Trackerless Torrenting” (attorney docket VADI 0424 PR), which provisional patent application is hereby incorporated by reference in its entirety into the present patent application.

### TECHNICAL FIELD

This invention pertains to the field of sending messages over open (i.e., unsecure) networks, such as the Internet, in a secure manner.

### BACKGROUND ART

As more and more digital data transmission takes place over open networks such as the Internet, the security of the data is becoming an increasingly important and serious issue for all users. This invention offers novel and powerful techniques for addressing these security issues.

### DISCLOSURE OF INVENTION

The present invention comprises apparatus, methods, and non-transitory computer readable media for securely sending a digital message from a sending device (1) to a recipient device (3) over an open network (4) such as the Internet. In a method embodiment of the present invention, a system controller (5) instructs the sending device (1) to segment the message into a finite number of segments having variable lengths; and assigns a variable number of relay (2) hops to each segment. The segments then flow from the sending device (1) to the recipient device (3) via several layers of conventional network relays (2). The number of relays (2) per layer is variable, and the number of layers encountered by a segment is variable. At least some of the segments are encrypted, by the sending device (1) and/or by one or more autonomous agent modules (30) operating on the relays (2). This invention makes it virtually impossible to track what is happening at the relays (2), or to identify the intended recipient (3). This virtually eliminates network traffic analysis as a viable means of compromising the security of the communications.

### BRIEF DESCRIPTION OF THE DRAWINGS

These and other more detailed and specific objects and features of the present invention are more fully disclosed in the following specification, reference being had to the accompanying drawings, in which:

FIG. 1 is a block diagram illustrating the basic components of the present invention.

FIG. 2 is a flow diagram illustrating steps performed at sending device 1.

FIG. 3 is a flow diagram illustrating steps performed at relays 2.

FIG. 4 is a flow diagram illustrating steps performed at receiving device 3.

### DETAILED DESCRIPTION OF PREFERRED EMBODIMENTS

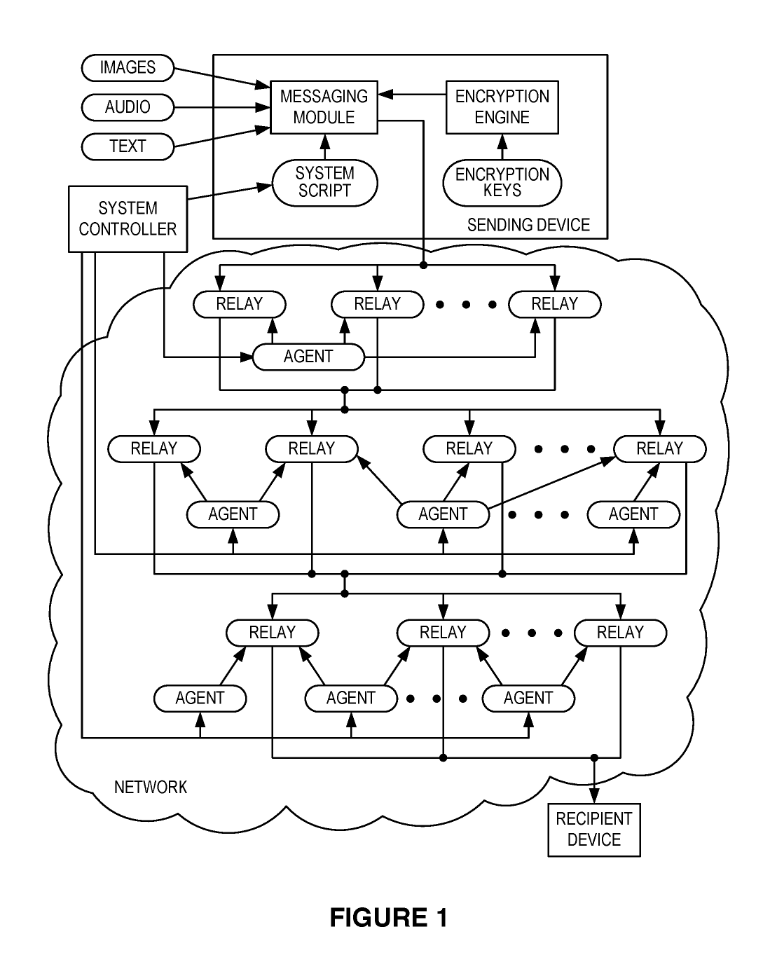

With reference to FIG. 1, a sending device 1 securely sends a message over an open (i.e., unsecure) network such as the Internet 4 to a recipient device 3. Sending device 1 and receiving device 3 have the same architecture. They are bidirectional, i.e., each of the illustrated sending device 1 and recipient device 3 is capable of both sending and receiving messages securely using this invention. Therefore, for purposes of simplicity, only the architecture of sending device 1 is elaborated upon in FIG. 1.

Sending device 1 comprises a messaging module 11 that is controlled by system script 17. System script 17 has been created by, and is dynamically updatable by, system controller 5. In turn, system controller 5 is controlled by at least one human system administrator, who is in charge of the operation of the overall inventive system.

Messaging module 11 formats the messages that the user of sending device 1 wishes to send securely to the recipient device 3. These messages can comprise images 12, audio 13, text 14, and/or any other digital information, file, or data. These messages can also comprise one or more encryption keys for any type of encryption system, whether it be one-time-pad (OTP) encryption, symmetric encryption, or asymmetric encryption. Thus, this invention, among other advantageous features, provides a means for secure key distribution, which has been a persistent and vexing problem in the field of secure communications over an open network.

The messages that are processed by messaging module 11 can be encrypted by an encryption engine 15 that is supplied with encryption keys by secure encryption key module 16. The encryption performed by encryption engine 15 can be any type of encryption, i.e., one-time-pad (OTP) encryption, symmetric encryption, and/or asymmetric encryption.

Messaging module 11 segments each outgoing message, as further described below, and causes the message to be sent over the network 4, which is usually the Internet, on its way to recipient device 3.

Network 4 comprises several (n in FIG. 1) layers of relays 2. These relays 2 are standard network devices, i.e., they are not proprietary to the present invention. A relay can be, for example, a Website that can receive posts, a blog, a message board, a music site, a video site, an Internet storefront, a dumb terminal, a mail box, a dead drop, or any Internet component that's available via a standard protocol such as FTP or SMTP. Relays 2 are in no way specific to the present invention and become usable in the present invention only through configuration of the agents 30 with which particular relays 2 are associated.

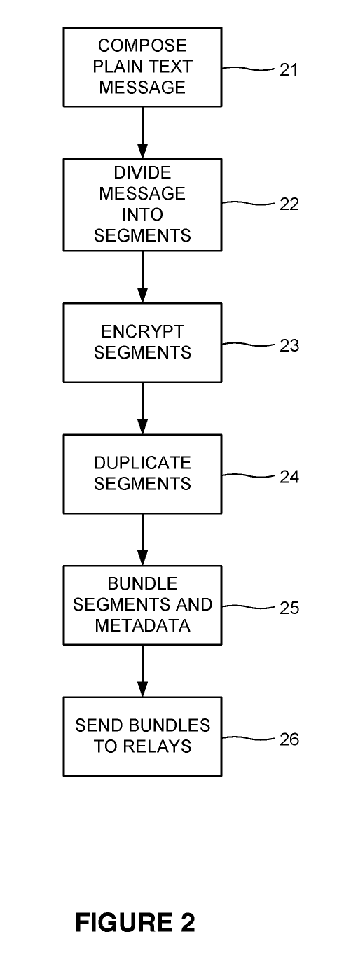

FIG. 2 illustrates the steps of message preparation that are performed by messaging module 11. At step 21, the user of sending device 1 composes a plaintext message that may include images 12, audio 13, text 14, and/or encryption keys 16. These items 12, 13, 14, 16 may already be associated with user device 1; alternatively, the creator of the message may spontaneously add images 12, audio 13, text 14, and/or one or more encryption keys 16 to the message where these items are not previously associated with user device 1.

The message can comprise any data or information in digital form, and have any function or use. This can include, but is not limited to, encryption keys for any type of encryption system, Word documents, spreadsheets, database files, financial transaction data, commerce data, and video files; and identification, authorization, and/or access control credentials.

At step 22, messaging module 11 divides the message into a preselected finite number of segments having variable lengths. The number of segments, the length of each segment, and the number of relay 2 hops to be traversed by each segment are dictated by dynamic system script 17.

At step 23, one or more of the segments are optionally encrypted by messaging module 11, which invokes encryption engine 15 for such a purpose.

At step 24, the segments are preferably duplicated, for purposes of redundancy. The main reason to duplicate the segments in this manner is to account for the possibility that one or more of the relays 2 that have been designated to relay one or more of the segments may be defective. This redundancy makes it possible for the recipient device 3 to reconstruct the message even in such an eventuality.

At step 25, messaging module 11 adds any metadata that may be associated with the segments and wraps the segments into envelopes, e.g. packets as defined by standard Internet protocols.

Also at step 25, messaging module 11 optionally encrypts one or more of the envelopes and/or the entire message. The encryption can be any type of encryption, e.g., one-time-pad (OTP), symmetric, or asymmetric, as long as the recipient device 3 has been preconditioned (programmed by controller 5) to decrypt the envelopes and/or message using the same algorithm. Still further at step 25, messaging module 11 optionally applies a hash function, which can be any standard hash function, to one or more of the segments, envelopes, and/or the entire message. This hashing is done to provide recipient device 3 with a means to check the integrity of the message, as is described in more detail below.

At step 26, messaging module 11 sends the packets (envelopes) over the network 4 to the first layer of relays 2(1) with appropriate headers or other metadata indicating the intended message recipient 3.

The user of sending device 1 is typically connected to the Internet 4 through a WiFi hotspot, wired network, or cellular network. The user activates messaging module 11 by pressing a button or other means, or else, in some embodiments, messaging module 11 opens itself.

Messaging module 11 comprises a processor, System on a Chip, artificial intelligence, or similar computing means. Messaging module 11 optionally automatically scans for attached devices that might contain new message content 12, 13, 14. If such new message content is found, these items are marked by messaging module 11 to be attachments to the outgoing message.

Encryption engine 15 encrypts the message, message segments, and/or message attachments using any type of encryption. The duplicated message segments, along with any metadata, may or may not be encrypted.

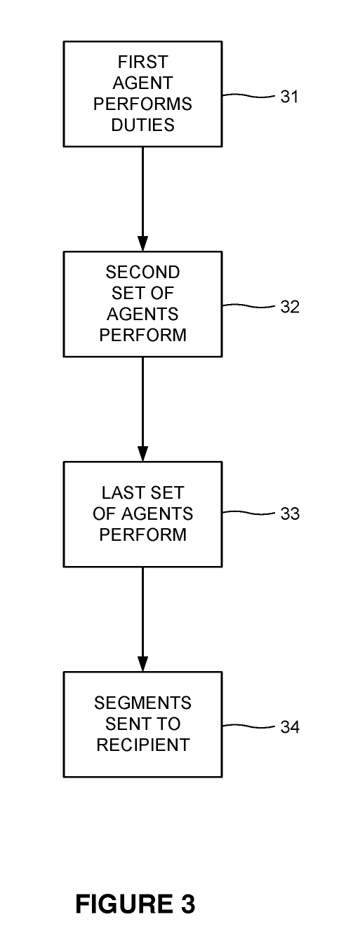

Activity within the relays 2 is illustrated in FIG. 3. System controller 5, via script 17 and similar scripts within agents 30, has pre-designated which relays 2 are to be traversed by which segments. Each relay 2 has an associated autonomous agent module 30 associated with that relay 2. There is not necessarily a one-to-one relationship between relays 2 and their associated agent modules 30. For example, as seen in FIG. 1, a single agent module 30(1) is associated with three relays: 2(1,1), 2(1,2), and 2(1,x).

A relay 2 is an existing (standard) network 4 device. An agent module 30, on the other hand, is part of this invention, and is a means to gain legitimate access to the relay 2 with which it is associated. For example, a relay 2 could be a gmail server, which acts to store and forward e-mail messages using the popular gmail software. In this case, agent module 30 can comprise a gmail account which has earned legitimate access to the gmail relay 2. System controller 5 has preprogrammed each agent module 30 to perform the desired functions on the particular relay(s) 2 associated with that agent 30, e.g., via a script. This programming can be dynamically changed by controller 5.

There can be several agents 30 associated with a single relay 2. For example, FIG. 1 shows that relay 2(2,2) is associated with two agents: agent 30(2,1) and agent 30(2,2). In the gmail example mentioned above, these two agents 30 can represent two different gmail accounts that have been registered with the gmail service.

With reference to FIG. 3, at step 31 the pre-configured agent 30 associated with the first layer of relays 2(1) observes each individual original and duplicate message segment and processes these items if such processing has been built into the script for that agent 30. Agent 30 optionally encrypts the original segment or duplicate segment that it observes. This encryption can use any type of encryption algorithm, e.g., one-time-pad (OTP) encryption, symmetric encryption, or asymmetric encryption. Different agents 30 can use different types of encryption (at the expense of slowing and complicating the workings of the system). The only requirement is that recipient device 3 must have been informed by controller 5 which segments are being encrypted with which algorithms, so that recipient device 3 can apply the appropriate decryption algorithms once it receives the message.

Preferably, for reasons of security, each original and duplicate segment should be encrypted at least once, whether by user device 1 or by one or more agents 30 that process the segment as it traverses from user device 1 to recipient device 3.

The first set of autonomous agents 30(1) then forwards the original segments and duplicate segments from the first layer of relays 2(1) to the designated second layer of relays 2(2).

There can be an arbitrary number x of relays 2 in the first layer, where x is an arbitrary positive integer. For purposes of simplicity, FIG. 1 shows three layer one relays 2(1). Similarly, there can be an arbitrary number of agents 30 associated with the first layer of relays 2(1). For purposes of simplicity, FIG. 1 illustrates one such agent 30(1).

Step 32 is where the second layer of relays 2(2) and associated agents 30(2) are active. Not every original segment and duplicate segment needs to be operated on at the second layer. At this second layer of relays 2(2), autonomous agents 30(2) processing their designated segments by operating upon the layer two relays 2(2) to which the layer 2 agents 30(2) have been assigned, as described above in conjunction with layer one.

FIG. 1 shows there are n layers of relays 2 and agents 30, where n is any positive integer. At step 33, the final processing of the remaining segments by the agents 30(n) is performed, in the manner described above.

At step 34, the agents 30(n) from the last remaining layer transmit all of the segments and duplicate segments to recipient device 3.

The above discussion should not be construed to mean that controller 5 necessarily knows which path a message will take. Controller 5 may define the path through judiciously configuring the agents 30, and may thus create stratas of agents 30, thus predefining the hops 2 a message will take. However, the agents 30 can be configured in a number of ways such that the array of relays 2 is scalable; the network 4 may be built in stratified layers or may be, for all intents, randomized; and the network 4 may change dynamically with the addition of configured agents 30. A relay 2 may be part of the network 4 on one day, and may disappear from the network 4 on the next day.

Much flexibility and power can be built into the agents 30. For example, an agent 30 can unwrap the transmission envelope and gain access to an encrypted message, and then manipulate the message again before resending it, all the while preserving security and privacy. A message that passes from one agent 30 to the next agent 30 may contain all, some, or part of a message. An agent 30 may take a portion of the message from a transmission envelope and resegment it, reduplicate it, and send it to one or more relays 2, not necessarily the “next” relay 2.

One of the key features of these configurable agents 30 is being able to discern network-specific characteristics of the message piece in question without being able to access any information at all about the sending device 1, the recipient device 3, or the plaintext. This allows an agent 30 to add more layers of obfuscation and uncertainty to the delivery of the message. Generally, the relays 2 can discern just the transmission envelope, metadata, and encrypted information; and the agents 30 can discern, in addition, the sender 1 to recipient 3 envelope information; but only the sender 1 and the recipient 3 can discern the underlying plaintext.

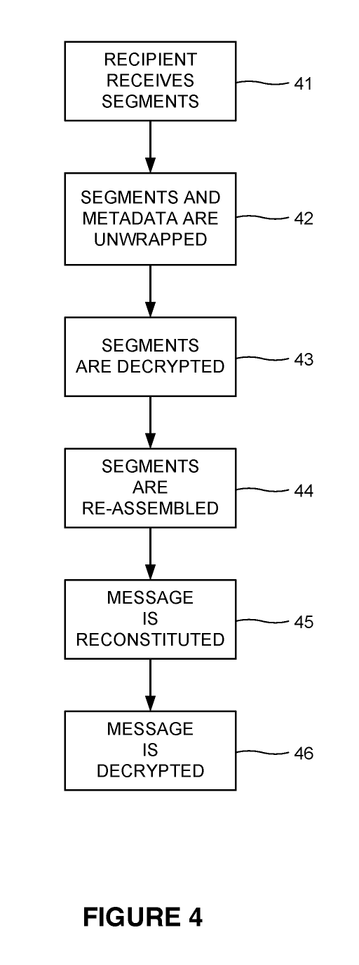

FIG. 4 illustrates the steps performed by recipient device 3. At step 41, recipient device 3 receives all of the original segments and duplicate segments from the last set of agents 30(n).

At step 42, recipient device 3 unwraps the segments and metadata out of any envelopes (packets) that may have been used by sending device 1.

At step 43, recipient device 3 decrypts those original and duplicate message segments and associated metadata that were encrypted, using the same encryption algorithms that were used to encrypt these message segments and metadata by user device 1 or by one or more agents 30.

At step 44, recipient device 3 reassembles the decrypted segments.

At step 45, recipient device 3 optionally performs integrity checks on the message for completeness and unalteration, by checking any hashes that were affixed to the message or segments by user device 1 at step 25. Also at step 45, recipient device 3 discards duplicate segments after being assured of the integrity and completeness of the corresponding original segments.

At step 46, recipient device 3 decrypts the entire message if the entire message was encrypted by user device 1 at step 25, and presents the message to the user of recipient device 3 by any conventional means, such as by displaying the message on a graphical display device.

If recipient device 3 wishes to send a return message to sending device 1, it may do so by following the above steps in reverse, using the same relays 2 and agents 30, or by using a partially or wholly different set of relays 2 and agents 30.

The script 17 in messaging module 11 and the similar scripts in agents 30 may be updated dynamically via metadata originating from system controller 5 as commanded by the human system administrator.

As seen from the above, the present invention offers the major advantage of enabling secure message transit across an open (unsecure) network 4. Another major advantage of the present invention is that it is virtually impossible to track what is happening at the relays 2, or to identify the intended recipient 3. This virtually eliminates network traffic analysis as a viable means of compromising the security of the communications. This advantage is made possible because: 1) the network 4 is a heterogeneous mix of relay 2 types (FTP, SMTP, Web blog, etc.); and 2) the message signature (the enveloped segments) can be changed at each hop 2 by one or more agents 30, thus making it difficult if not impossible to trace which segment entered and left which relay 2.

Furthermore, many of the relay 2 types that can be used in the present invention introduce a time delay into the system, further obscuring traffic analysis. For example, if an agent 30 moves a segment via an FTP-to-FTP relay 2, there can be a delay of seconds, minutes, hours, or even days before another agent 30 picks up that segment and moves it on to the next relay 2.

In one embodiment of the present invention, an agent 30 may unpack an envelope, add a hash, and possibly re-encrypt the contents of an envelope before passing it on. This further frustrates any attempts to follow a segment from one relay 2 to the next relay 2, because the message signature has changed. Since the recipient 3 is not treated any differently than any other relay 2 in the system, it becomes very difficult to track the path of an originating message/segment and its true final destination 3. Essentially, each relay 2 acts as a digital dead drop, and incoming/outgoing message segments are altered to obscure where these segments came from and where they are going.

In an embodiment of the present invention, white noise traffic can be distributed to some or all of the relays 2 to further disrupt the possibility of tracking messages. In yet another embodiment of the present invention, some of the relays 2 are intentionally designed to be short-lived, i.e., they are brought up and down on distributed cloud services to thwart long-term attack vectors on these relays 2.

All of the inventive modules described in this specification can be implemented in any combination of hardware, software, and firmware. When implemented in software, the modules can be embodied in any one or more non-transitory computer readable media, such as one or more hard disks, thumb drives, optical disks, etc.

The above description is included to illustrate the operation of preferred embodiments, and is not meant to limit the scope of the invention.

The scope of the invention is to be limited only by the following claims. From the above discussion, many variations will be apparent to one skilled in the art that would yet be encompassed by the spirit and scope of the present invention.

What is claimed is:

1. A method for securely sending a digital message from a sending device to a receiving device over an open network, said method comprising a system controller performing the steps of:
instructing the sending device to segment the message into a finite number of segments having variable lengths; and
assigning a variable number of relay hops to each segment; wherein
the segments flow from the sending device to the receiving device via several layers of conventional network relays; and
at least some of the segments are encrypted.

2. The method of claim 1 wherein the segments are encrypted at some combination of the sending device and at least one relay.

3. The method of claim 2 wherein encryption at a relay is performed by an autonomous agent module as instructed by the system controller.

4. The method of claim 3 wherein the relationship between the number of relays and the number of agents is other than one-to-one.

5. The method of claim 1 wherein the system controller instructs a messaging module within the sending device via a dynamically changeable script.

6. The method of claim 1 wherein the sending device duplicates the segments before sending them over the open network.

7. The method of claim 1 wherein the encryption is performed by at least one of one-time-pad encryption, symmetric encryption, and asymmetric encryption.

8. The method of claim 1 wherein the message comprises an encryption key.

9. The method of claim 1 wherein the sending device applies a hash algorithm to at least one of the message and at least some of the segments prior to sending the segments over the open network.
